(19) United States
(12) Patent Application Publication
(10) Pub. No.: US 2021/0284320 A1
(43) Pub. Date: Sep. 16, 2021

(54) GUIDING ELEMENT FOR A HIGH LIFT AIRFOIL ARRANGEMENT OF AN AIRCRAFT, HIGH LIFT AIRFOIL ARRANGEMENT AND PRODUCTION METHOD

(71) Applicant: Airbus Operations GmbH, HAMBURG (DE)

(72) Inventors: Stefan BAUER, HAMBURG (DE); Alexander HUBER, HAMBURG (DE); Florian LORENZ, HAMBURG (DE); Bernhard SCHLIPF, HAMBURG (DE)

(21) Appl. No.: 17/195,753

(22) Filed: Mar. 9, 2021

(30) Foreign Application Priority Data
Mar. 11, 2020 (DE) 102020106670.8

(51) Int. Cl. B64C 9/02; B64C 3/18; B64C 9/24

(52) U.S. Cl. CPC B64C 9/02; B64C 9/24; B64C 3/187

(57) ABSTRACT

An aircraft high lift airfoil arrangement guiding element includes a first part configured to be fixed to a first edge member or rib of the airfoil arrangement, and a second part including a track support element to movably support a track device of a second edge member or slat of the airfoil arrangement. The second part is mounted to the first part to move from a first to a second position. A biasing device biases the track support element in the spanwise direction towards the track device. The airfoil arrangement is produced by providing the first edge member or rib, rigidly attaching thereto guiding elements to guide the movable track device supporting the second edge member or slat, and attaching the track device to the first edge member. During installation, a surface of the track device is pressed against a movable track support element biased against the track device.

### CROSS-REFERENCES TO RELATED APPLICATIONS

This application claims the benefit of the German patent application No. 102020106670.8 filed on Mar. 11, 2020, the entire disclosures of which are incorporated herein by way of reference.

### FIELD OF THE INVENTION

The invention relates to a guiding element for a high lift airfoil arrangement of an aircraft, a high lift airfoil arrangement for an aircraft, and to an aircraft wing as well as an aircraft equipped with said airfoil arrangement. Further, the invention relates to a method for producing a high lift airfoil arrangement for an aircraft.

### BACKGROUND OF THE INVENTION

Aircraft wings are usually equipped with high-lift airfoil arrangements which influence the airflow for generating a high lift during specific flight phases. Such arrangements may, for example, comprise a slat supported by a track which is movably attached to a fixed leading edge of the wing. In this way the slat can be moved between a retracted position, where it is close to the fixed leading edge, and an extended or deployed position. It is usually moved on a curved path forward and downward relative to the fixed leading edge to come to the deployed position.

In most aircraft, the guidance of a leading edge track, for example, is realized by rollers supporting the track on the upper and lower side, in combination with side rollers and possibly with gliding parts, which may be attached to the leading edge ribs. As a part of the leading edge high-lift system, the track may be deploying and retracting a slat in certain stages of flight, thereby allowing the wing to operate at higher angles of attack (AoA).

The roller guidance may support the track in retracted condition, during movement, and while the slat is fully deployed.

WO 2018/197 265 A1 discloses a wing for an aircraft, comprising a main wing, a slat, and a connection assembly for movably connecting the slat to the main wing. The connection assembly comprises an elongate and curved slat track and a first bearing as well as a second bearing. The track is movably supported on the main wing by the first and second bearing.

WO 2018/197 649 A1 discloses a wing for an aircraft, comprising a main wing and a connection assembly movable connecting a slat to the main wing. The connection assembly comprises an elongate slat track, wherein the rear end and the intermediate portion of the slat track are mounted to the main wing by a roller bearing comprising a guide rail mounted to the main wing and a first roller unit mounted to the rear end of the slat track and engaging the guide rail. The roller bearing comprises a second roller unit mounted to the main wing and engaging an engagement surface at the intermediate portion of the slat track.

In recent concepts for wings, the upper and lower roller may be supported by at least one cantilever-roller (attached to the rib and rolling inside the track, which may also be designated as a ‘support roller’) and a rear roller (attached to the track itself and running inside guidance rails).

The guidance may be designed as two elements: the upper and lower rail, on which the rear roller can move while extending or retracting the slat. The rail may be attached to the leading edge ribs.

In a known high-lift airfoil arrangement of an aircraft, a slat is for example supported by a slat track which is movably attached to a fixed leading edge. The slat track with the slat at its front end can be moved forward and downward on a curved track to move into a deployed or extended position, and to move back into a retracted position. Rollers may guide the slat track on its upper side and its bottom side. For example, one roller pair can be located in the forward area of the fixed leading edge, and one roller pair can be located in the rear area, just in front of the front spar. Side rollers may provide a side load guidance of the slat track.

Depending on the wind and the flight conditions, the loads acting on a slat track can be very high and may vary in a wide range, e.g., when gusts occur. Therefore, the slat track must take high loads with strong variations, and these loads need to be transferred from the slat track to the fixed leading edge of the aircraft wing. Therefore, the guidance of the slat track must be very precise when it is moved and must have low clearances.

To guarantee a precise guidance of the slat track by various roller assemblies, a high accuracy is necessary during installation of the slat track and the roller assemblies. Many installation steps have to be performed in a specific sequence. In particular, several measurements of the position of the slat track and the rollers have to be performed, shim plates need to be installed between the different installation steps in order to adjust the roller position to the position of the slat track, and measurements have to be repeated in order to achieve the precise guidance of the slat track when it is installed. As a consequence, the installation of slat tracks is time-consuming and generates undesirable added costs.

### SUMMARY OF THE INVENTION

It is an object of the invention to decrease the installation time and increase the production rate in order to reduce the production costs of high-lift airfoil arrangements.

The invention provides a guiding element for a high lift airfoil arrangement of an aircraft, comprising: a first part configured for being fixed to a first edge member of an high lift airfoil arrangement of an aircraft; a second part comprising at least one track support element configured for movably supporting a track device of a second edge member of the high lift airfoil arrangement, wherein the second part is movably mounted to the first part and configured to move from a first position to a second position; and a biasing device configured to bias the track support element in a spanwise direction towards the track device.

In particular, the first part is fixable to the first edge member and is also referred to as a fix part or fixed part. In particular, the second part is movable relative to the first part and is also referred to as a moving part.

In particular, the biasing direction is the spanwise direction of the wing. It may also be the spanwise direction of the high-lift airfoil arrangement. In particular, the spanwise direction may be parallel to the leading edge of the wing or the high-lift airfoil arrangement. It may also have an additional component in the direction of the longitudinal or the lateral axis of the aircraft, so that it deviates from being parallel to the leading edge of the wing or the high-lift airfoil arrangement. In particular it extends in the plane of the wing, for example between the fuselage of the aircraft and the wing tip.

Preferably, the track support element comprises a roller configured for rolling on a surface of the track device.

Preferably, the track support element comprises a gliding member configured for gliding on a surface of the track device.

Preferably, the biasing device is compressible to adapt the position of the second part according to varying positions of the track device while pressing the second part against the track device.

Preferably, the first part comprises a gliding surface for supporting the guiding element on the surface of the track device when the second part is in a retracted position. Thus, in the unlikely event of a failure, the track device remains movable and is still guided by the guiding element. In this way, the operational reliability is improved.

Preferably, a liner that is formed of, or comprising a surface coating formed of, a material with a relatively low coefficient of friction is arranged in the track contact area of the first part to form the gliding surface and to reduce friction. The material may further be a self-lubricating type of material. Thus, the liner is, for example, a self-lubricating liner.

Preferably, the biasing device is configured so that the first part may contact the track device when a predetermined maximum load acting against the biased track support element is exceeded.

Preferably, the biasing device comprises one or more springs pressing the second part in the direction of its extended position.

Preferably, the biasing device is configured to press the track device by a predetermined force against a guiding element that is located on the opposite side of the track device.

Preferably, the at least two springs have different stiffness values depending on the predetermined position of the guiding element when fixed to the first edge member.

Preferably, the guiding element comprises one or more fasteners, each fastener adapted to rigidly attach a portion of the first part to the first edge member of the airfoil arrangement and/or for retaining a corresponding spring such that the spring may provide a predetermined force to the second part in the direction of its extended position. Preferably the fasteners are formed as bolts.

Preferably, the second part is at least partly arranged within a frame or chamber formed by the first part and at least a portion of the track support element protrudes from the frame or chamber when the second part is moved in the direction of the extended position.

Preferably, the first edge member is a rib of the airfoil arrangement.

Preferably, the second edge member is movably supported by the track device, which is configured to be moved relative to the first edge member.

Preferably, the first edge member and the second edge member are leading edge members.

Preferably, the guiding element is configured as a track side guiding element for absorbing side loads acting on a track of the airfoil arrangement.

Preferably, the guiding element is configured for being mounted to an airfoil arrangement for extending and retracting the second part in the spanwise direction.

According to an aspect of the invention, a high-lift airfoil arrangement for an aircraft is provided, comprising a first edge member, a track device which is movable with respect to the first edge member and supporting a second edge member, and a guiding element according to the invention.

Preferably, the first edge member and the second edge member are leading edge members.

Preferably, the high lift airfoil arrangement is a slat arrangement.

According to a further aspect of the invention, an aircraft wing is provided, comprising a high lift airfoil arrangement according to the invention.

According to a further aspect of the invention, an aircraft is provided comprising a high lift airfoil arrangement according to the invention, and/or an aircraft wing according to the invention.

According to a still further aspect, the invention provides a method for producing a high lift airfoil arrangement for an aircraft, comprising the steps:

a) providing a first edge member of the high lift airfoil arrangement;

b) rigidly attaching to the first edge member one or more guiding elements for guiding a movable track device which is configured for supporting a second edge member of the high lift airfoil arrangement;

c) attaching the movable track device to the first edge member, wherein a surface of the track device is pressed against a movable track support element of at least one guiding element which is biased in the spanwise direction against the track device.

Preferably, in step (b), at least one pair of guiding elements is attached on opposite sides of the track device before step (c) is performed.

Preferably, at least one of the guiding elements is a guiding element according to the invention.

The design and method proposed by the invention increases the production rate of high-lift airfoil arrangements, reduces the production time and costs, and improves the operational reliability of the aircraft.

### BRIEF DESCRIPTION OF THE DRAWINGS

Embodiments of the invention are described in more detail with reference to the accompanying drawings.

FIG. 1 depicts an aircraft according to the invention;

FIGS. 2A and 2B depict an airfoil arrangement according to a preferred embodiment of the invention as a side view, wherein a slat is in a retracted position (FIG. 2A) and in a deployed position (FIG. 2B);

FIG. 3 depicts a frontal section view of an airfoil arrangement according to a preferred embodiment of the invention;

FIG. 4 is an enlarged partial view of FIG. 3, showing in detail the contact between the guiding element and the track device;

FIG. 5 is a view similar to FIG. 3, however with guiding elements according to the invention arranged only at one side of the track device;

FIG. 6 depicts a view on a guiding element according to the invention which is installed in a rib of an airfoil arrangement;

FIG. 7 depicts a view on the opposite side of the guiding element shown in FIG. 6, which is configured for supporting a slat track;

FIG. 8 depicts a sectional view of the guiding element installed in a rib, wherein a roller of the guiding element is in contact with a track device;

FIG. 9 depicts a sectional view similar to FIG. 8, wherein a gliding member of the guiding element is in contact with the track device; and

FIG. 10 depicts a front view of an aircraft according to the invention, with wings equipped with an airfoil arrangement according to the invention.

### DETAILED DESCRIPTION OF THE PREFERRED EMBODIMENTS

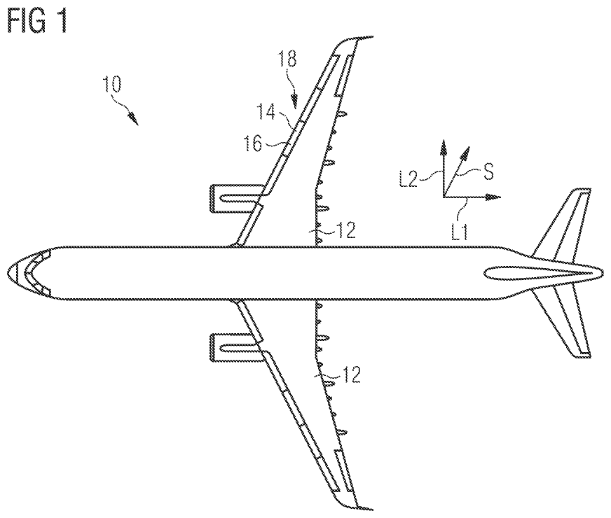

Reference is made to FIG. 1 which depicts an aircraft 10. The aircraft 10, in a usual manner, comprises a pair of wings 12. Each wing 12 is equipped with at least one high-lift device 14, for example a slat 16.

Each wing 12 extends in a direction which usually has components of three axes of the aircraft 10 being orthogonal to each other, namely a longitudinal axis L1, a lateral axis L2 and a vertical axis V, which is orthogonal to the image plane of FIG. 1 and shown in FIG. 10.

Usually the direction in which the wing 12 extends between the fuselage of the aircraft and the wing tip is called the spanwise direction S of the wing. The spanwise direction S extends in the plane of the wing 12. In particular, it may be parallel to the leading edge of the wing 12. However, it may also deviate from being parallel to the leading edge in certain cases, depending on the specific shape of the wing. The spanwise direction S, is also depicted in FIG. 10, together with the vertical axis V and the lateral axis L2.

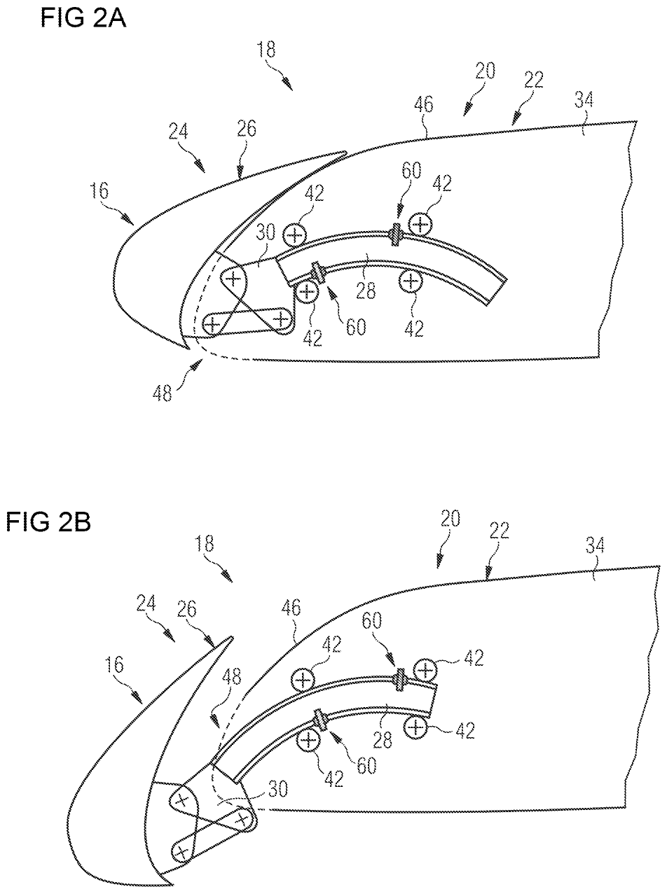

The wing 12 or a portion thereof and the high-lift device 14 may form a high-lift airfoil arrangement 18, as depicted in FIG. 2, for example. Its spanwise direction is, for example, the same direction as the spanwise direction S of the wing 12 or parallel thereto.

Referring now to FIGS. 2A and 2B, the airfoil arrangement 18 comprises a fixed edge member 20. The fixed edge member 20 may be configured as a fixed leading edge member 22.

The airfoil arrangement 18 may further include a movable edge member 24. The movable edge member 24 may be configured as a movable leading edge member 26. The movable edge member 24 may be, for example, the high-lift device 14, as, e.g., shown in FIG. 1. In particular, the movable leading edge member 26 may be the slat 16.

The airfoil arrangement 18 further includes a track device 28. The track device 28 can be moved between at least one extended position (see FIG. 2A) and a retracted position (see FIG. 2B). The track device 28 is further configured to support the movable edge member 24. In particular, the track device 28 comprises a link 30, which connects the track device 28 with the movable edge member 24.

The fixed edge member 20 comprises a plurality of ribs 34. The ribs 34 are spaced apart from each other in a spanwise direction, for example.

The fixed edge member 20 may further comprise a guiding rail arrangement preferably attached to the ribs 34, which is not shown in the Figure. It may be configured such that the track device 28 engages the guiding rail arrangement. It may include an upper guiding rail and a lower guiding rail, which are parallel and curved.

The fixed edge member 20 may further comprise support rollers 42 fixed to the rib 34. The support rollers 42 engage the track device 28, so as to support the track device 28. The support rollers 42 are arranged as pairs, where one roller is on the upper side and one roller is on the bottom side of the track device 28.

The fixed edge member 20 further comprises an outer skin 46, which forms an aerodynamic surface. The outer skin 46 includes a track device opening 48. The track device opening 48 may be formed as a cut-out of the outer skin 46. The track device opening 48 allows for the track device 28 and the link 30 to move between the retracted position and the extended position.

Guiding elements 60 comprising track side rollers are installed in the rib 34 which forms an edge member of the airfoil arrangement 18.

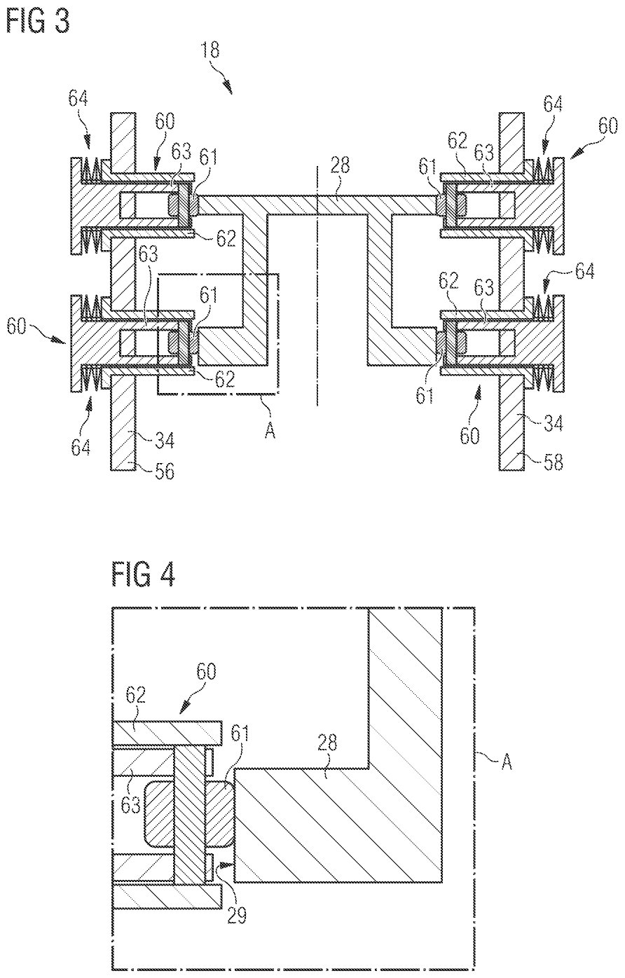

Referring now to FIG. 3, the guiding elements 60 attached to the ribs 34, i.e., the inboard rib 56 the outboard rib 58 of the airfoil arrangement 18, are explained in detail.

Each guiding element 60 is configured as a roller assembly which is installed within the rib 34, 56, 58 and extending through the rib 34, 56, 58 in a through-hole thereof. On the side of the ribs where the track device 28 is installed, the guiding elements 60 contact the track device 28 from opposing sides by side rollers 61 which are part of the guiding elements 60. In this way, the track device 28 is movably held between the rollers 61 arranged on both sides, so that it can move forward and backward relative to the ribs 56, 58, i.e., in the longitudinal direction of the track device 28, which is perpendicular to the plane of the drawing shown here.

The ribs 56, 58 are parts of a first edge member of an airfoil arrangement of an aircraft 10 as shown in FIG. 1, in this case a fixed leading edge member 22.

Each guiding element 60 has a first part 62 fixed to the rib 56, 58, which is a leading edge rib. A second part 63 of the guiding element 60 is able to float inside the fix part 62. In this way, it can move in a direction perpendicular to the rib plane.

In the following, the first part 62 is also referred to as fixed part 62, and the second part 63, which is movable relative to the first 62, is also referred to as moving part 63.

The moving part 63 is preloaded by a biasing member formed as a spring 64 in this embodiment. In this way the moving part 63 is biased in the direction to the rib 34, and thus also to the other side of the rib 34. Thus, the moving part 63 is movably mounted to the fixed part 62 and able to move from a first position to a second position relative to the fixed part 62 and thus also relative to the rib 34, 56, 58.

Since the biasing member or spring 64 presses the moving part 63 by a force against the track device 28, the track device 28 is pressed by that force against the guiding element 60 which is positioned on the opposite side of the track device 28. The guiding element located on the opposite side may also be configured as depicted in FIG. 5 described below.

FIG. 4 shows an enlarged partial view A of FIG. 4 showing the roller 61 of the guiding element 60 in contact with a portion of the track device 28 which is a slat track in this embodiment.

As shown in FIGS. 4 and 5, the guiding elements 60 are configured as a side guidance of track device 28. Each roller 61 is configured for rolling on a supporting surface 29 of the track device 28, which forms a roller contact surface 29. Here, the track device 28 is a slat track and the rollers 61 are designed as side rollers.

FIG. 5 is a view similar to FIG. 3 and shows a further embodiment of the invention. Here, the guiding elements 60 according to the invention are installed only in the rib 56 on one side of the track device 28 and referred to as first guiding elements. The second guiding elements 70 installed in rib 58 and comprising rollers 71 are not part of the invention. Nevertheless, also in this configuration the tolerances between the track device 28 and the opposing guiding elements 60, 70 are reduced to zero, even if the guiding element 60 according to the invention is only installed in the rib 56 at one side of the track device 28.

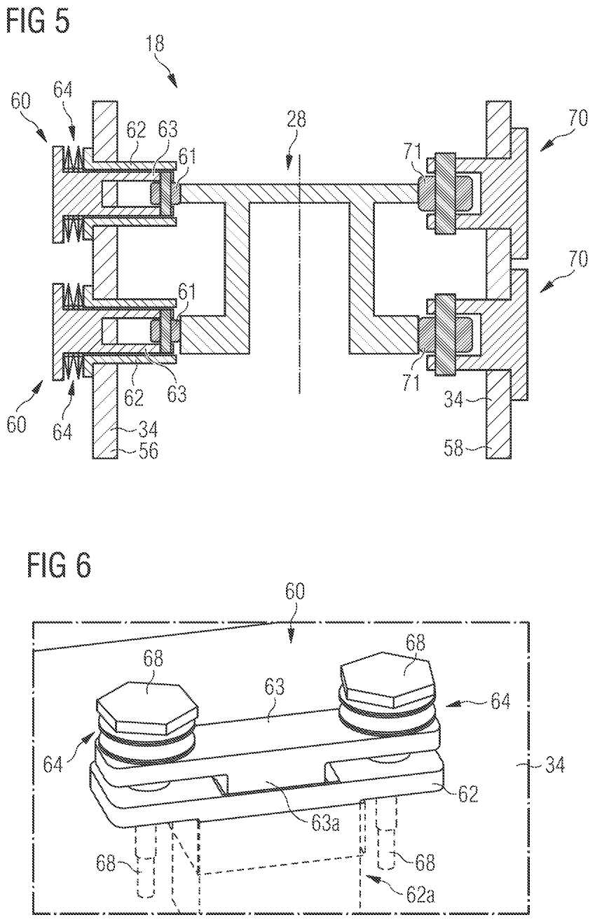

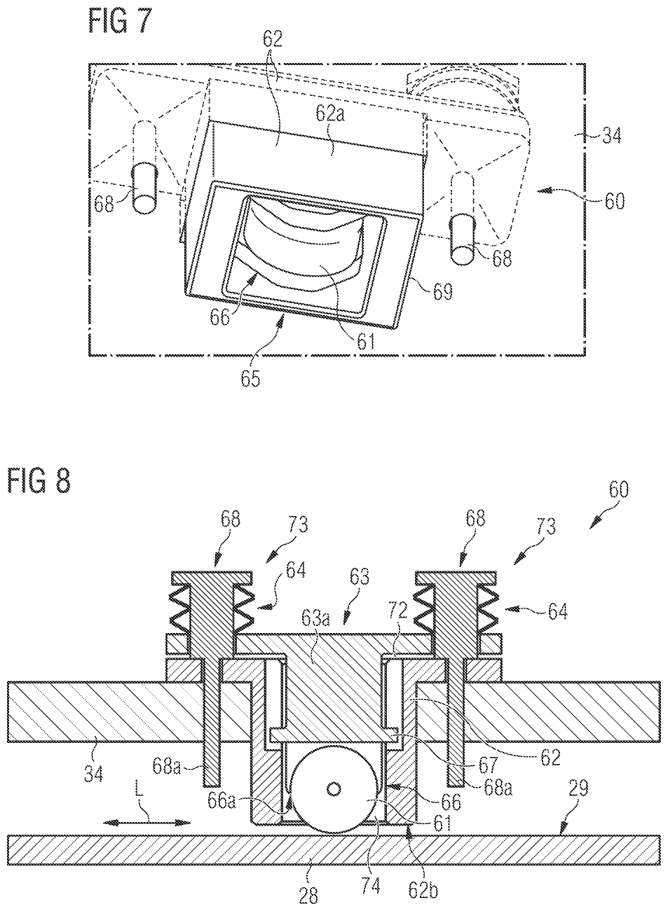

With reference to FIGS. 6 and 7, further details of the guiding element 60 are described in the following. In these figures, the roller assembly or guiding element 60 is installed in the rib 34, e.g., in the rib 56 and/or in the rib 58 as shown in FIGS. 4 to 6. FIG. 6 shows a view on the side of rib 34 which is not facing the track device 28, whereas FIG. 7 shows a view on the side of rib 34 facing the track device 28. The rib 34 is depicted in a slightly transparent manner in both figures, so that the contours of the portion of the guiding element 60 which is within or behind the rib 34 in the respective figure are visible.

The fixed part 62 of guiding element 60 is fixedly attached to the rib 34 by two fasteners formed as bolts 68. A portion 62a of the fixed part 62 extends into and through the rib 34. Thus, the fixed part 62 of the guiding element 60 extends through the rib 34 in a through hole thereof from a first side of the rib 34 to a second side of the rib 34 where the track device 28 is located (see FIG. 6).

A portion of the fixed part 62 protrudes from the second side of the rib 34, where the track device 28 is arranged or will be arranged (see FIG. 7). Track device 28 is not visible in the figure. FIG. 7 shows a view on the area or the side of the guiding element 60, which will be in contact with the track device 28 when installed.

The moving part 63 of guiding element 60 is movably attached to the fixed part 62 at the side of the fixed part 62 opposite to the rib 34 (see FIG. 6). A portion 63a of the moving part 63 extends inside the fixed part 62 and its portion 62a and thus extends from one side of the rib through the rib 34 to the other side of the rib 34. The moving part 63 is biased by two springs 64 in the direction of the fixed part 62 and thus in a direction orthogonal to the plane of the rib 34 to the track device 28. One end of each spring 64 is stationary held by abutting against a head portion of the bolt 68 (in other words each spring 64 is retained by the bolt 68), whereas the other end of each spring 64 is movable and pressing against the moving part 63.

The fixed part 62 forms a housing 69 surrounding the roller 61 of the guiding element 60. The roller 61 is mounted to the moving part 63 extending through the rib 34.

The housing 69 is, in particular, formed by the portion 62a of the fixed part 62. The housing 69 has an opening 65 on the side where the guiding element 60 contacts the track device 28. Thus, the roller 61 which is mounted to an end portion 66 of the moving part 63, is able to extend though the opening 65 and to protrude therefrom in order to contact and to support the track device 28. The end portion 66 of moving part 63 forms in this way a track support element 66 which is movably supporting by its roller 61 the track device 28.

In addition or alternative to the roller 61, the track support element 66 formed by the end portion of the moving part 63 may comprise a gliding member which is configured for gliding on the track device 28, i.e., on its contact surface 29 depicted in FIG. 4.

FIG. 8 depicts a sectional view of the guiding element 60 as described above installed in the rib 34, where the roller 61 is in contact with the track device 28. The rib 34 is, for example, the rib 56, 58 shown in FIGS. 3 to 5.

The track device 28 contacting the roller 61 with its surface 29 is movable in its longitudinal direction L relative to the guiding element 60 and the rib 34. The roller 61 is attached to the moving part 63 of the guiding element 60, i.e., at the end portion which forms the track support element 66 of the moving part 63. The moving part 63 floats with its portion 63a inside the fixed part 62 in a chamber 74 formed by the fixed part 62. The fixed part 62 is rigidly attached to the rib 34. Rib 34 may form a fixed leading edge member.

A guidance member 67 is arranged between the fixed part 62 and the moving part 63 to keep the moving part 63, in the correct position. The guidance member 67 is formed as a protruding portion of the moving part 63 located within the fixed part 62.

The moving part 63 is loaded with the springs 64 and presses with the roller 61 against the track device 28. End portions 68a of the bolts 68 are extending through the fixed part 62 and the rib 34 to fixedly connect both. The springs 64 are held in place with the bolts 68. In this embodiment, two bolts 68 and two springs 64 are provided. Each bolt 68 together with spring 64 forms a biasing device 73. The bolts 68 have two functions, namely to provide a guide for the moving part 63, and to attach the fixed part 62 to the rib 34 which is configured as a leading edge member.

The state depicted in this figure is a normal operating situation. Here, the roller 61 is in contact with the track device 28 and a relatively small gap 72 exists between the fixed part 62 and the moving part 63. The springs 64 and the moving part 63 are pre-tensioned but not fully compressed.

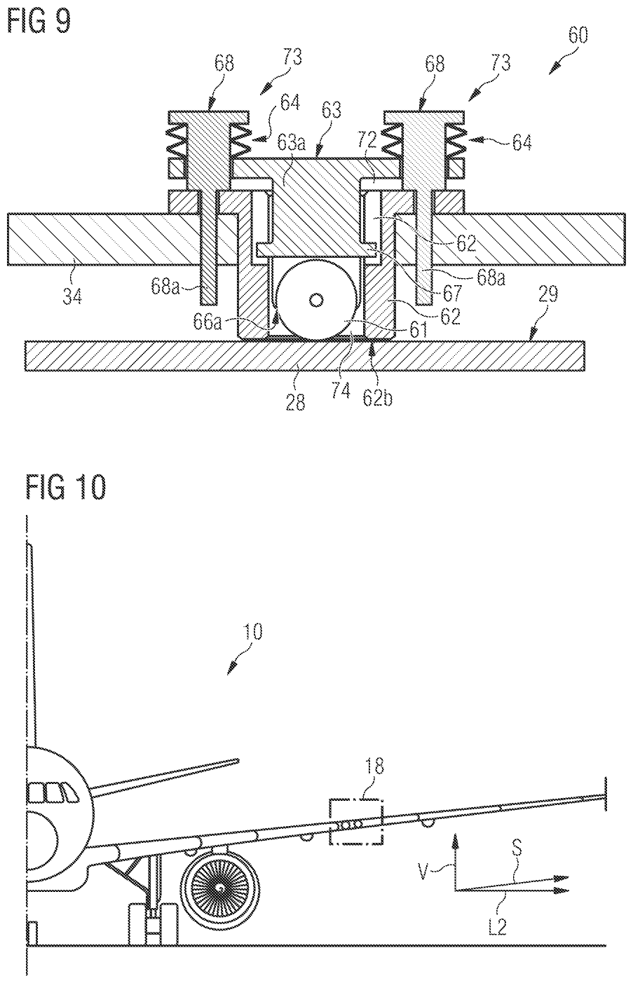

FIG. 9 shows the roller assembly which forms the guiding element 60 in a state where track side loads are higher than during normal operating cases. The roller 61 is pressed by the track device 28 against the force of the springs 64, which are compressed until the fixed part 62 gets in contact with the track device 28. In that way, part of the load is transferred directly into the fixed part 62 and into the rib 34. The gap 72 between the fixed part 62 and the moving part 63 is bigger than in the state shown in FIG. 8.

In a preferred embodiment of the invention, a fixed part contact area formed by surface 62b of the fixed part 62 which gets in contact with the track device 28, is provided with a gliding liner to avoid excessive wear or fretting. Preferably the material used as the gliding liner is a self-lubricating material. The gliding liner may be formed of KAron® offered by KAMAN, or any suitable equivalent.

In a further preferred embodiment of the invention, the contact area 62b comprises an indication paint applied to its surface facing the track device 28, which indicates when a contact between the contact area 62b and the track device 28 occurred. By implementing an indication paint in the contact area 62b, a complete compression of the guiding element 60 during flight is visible when maintenance checks are made.

FIG. 10 depicts a frontal view of an aircraft 10 having wings according to the invention, which comprise a high lift airfoil arrangement 18 as discussed above. The high lift airfoil arrangement 18 is equipped with guiding elements 60 as described above.

Each wing 12 extends in the spanwise S direction having components of the longitudinal axis L1, the lateral axis L2 and the vertical axis V, which axes are orthogonal to each other as described above with reference to FIG. 1. In FIG. 10, the longitudinal axis L1 is orthogonal to the image plane.

In the example shown here, the high lift airfoil arrangement is configured as a slat arrangement. However, the high lift airfoil arrangement can also be a flap arrangement or it can be configured as a flap arrangement

An example of a method for producing a high lift airfoil arrangement for an aircraft according to the invention is described in the following with reference to FIGS. 2 and 8.

In a first step, a first edge member 20 formed by a rib 34 of a high lift airfoil arrangement 18 is provided.

Then, one or more guiding elements 60 as described above, which are configured for guiding a movable track device 28, are rigidly attached to the first edge member or rib 34. The track device 28 has the function of supporting a second edge member 24 of the high lift airfoil arrangement 18, which may be a slat 16.

Thereafter, the track device 28 is attached to the first edge member 20, i.e., to the rib 34, wherein a surface 29 of the track device 28 is pressed against a movable track support element formed by a portion 66 of the moving part 63 of the guiding element 60. During installation of the track device 28, the track support element 66 is biased against the track device 28.

Before the track device 28 is attached to the first edge member 22, at least one pair of first and second guiding elements 60 may be attached on opposite sides of the location of the track device 28.

A guiding element according to the invention as described above may be used as at least one of the first and second guiding elements 60.

In particular, all guiding elements 60 may be installed before the track device 28 is installed.

The guiding element 60 according to the invention absorbs all tolerances and makes measurements and shim installations obsolete, which are necessary in the prior art during the production of high-lift airfoil arrangements. The spring-loaded roller assembly forming the guiding element 60 is equipped with biasing elements in form of springs 64 having a biasing force or spring tension which is designed in a way that all operating loads can be transferred into the 34 without exceeding the spring deformation limit.

In further preferred embodiments, different guiding elements 60 having different biasing forces or spring stiffness are installed in one rib 34, 56, 58. The biasing force or spring stiffness is selected according to the position of the guiding element within the rib 34, 56, 58, depending on the load which is transferred at that position from the track device 28 via the guiding element 60 to the rib 34, 56, 58.

The invention allows a quicker installation process without measurements and packer or shim installation. The roller loads can be limited to normal operating loads. The invention effects a gap compensation in case of material wear. No gaps and free play are achieved. The track installation is feasible with roller already installed. An indication of exceeded load can be implemented. The invention relates to an increased reliability of high lift airfoil arrangements and improves the safety of aircraft. In particular, even in case of a failure, the track device is kept movable.

Since the guiding element 60 is configured to support the track device 28 in a sliding manner with its fixed part 62 in addition to the roller 61 when usual loads are exceeded, operation of the airfoil arrangement, i.e., movement of the movable edge member 24 or slat 16 may be retained, even in a failure condition.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 slat
2 slat track
3 fix leading edge
4 rollers
10 aircraft
12 wing
14 high-lift device
16 slat
18 airfoil arrangement
20 fixed edge member
22 fixed leading edge member
24 movable edge member
26 movable leading edge member
28 track device
29 surface
30 link
34 ribs
42 support roller
46 outer skin
48 track device opening
56 inboard rib
58 outboard rib
60 guiding element
61 roller/side roller
62 first part or fixed part
62a portion of first part
62b contact surface of first part
63 second part or moving part
63a portion of second part
64 spring/biasing member
65 opening
66 track support element/end portion of moving part
66a gliding member
67 guidance member
68 fastener/bolt
68a end portion
69 housing
70 second guiding element
71 rollers
72 gap
73 biasing device
74 chamber
L longitudinal direction of the track device
L1 longitudinal direction of the aircraft
L2 lateral direction of the aircraft
V vertical direction of the aircraft
S spanwise direction of the wing or the high-lift airfoil arrangement

1. A guiding element for a high lift airfoil arrangement of an aircraft, comprising:
a first part configured to be fixed to a first edge member of a high lift airfoil arrangement of an aircraft;
a second part comprising at least one track support element configured to movably support a track device of a second edge member of the high lift airfoil arrangement,
wherein the second part is movably mounted to the first part and configured to move from a first position to a second position; and
a biasing device configured to bias the at least one track support element in a spanwise direction towards the track device.

2. The guiding element according to claim 1, wherein the at least one track support element comprises a roller configured to roll on a surface of the track device.

3. The guiding element according to claim 1, wherein the at least one track support element comprises a gliding member configured to glide on a surface of the track device.

4. The guiding element according to claim 1, wherein the biasing device is compressible to adapt a position of the second part according to varying positions of the track device while pressing the second part against the track device.

5. The guiding element according to claim 1, wherein the first part comprises a gliding surface for supporting the guiding element on the surface of the track device when the second part is in a retracted position.

6. The guiding element according to claim 1, wherein the biasing device is configured to allow the first part to contact the track device when a predetermined maximum load acting against the at least one biased track support element is exceeded.

7. The guiding element according to claim 1, wherein the biasing device comprises one or more springs pressing the second part in a direction of an extended position.

8. The guiding element according to claim 7, wherein the one or more springs comprises at least two springs which have different stiffness values depending on a predetermined position of the guiding element when fixed to the first edge member.

9. The guiding element according to claim 1, comprising one or more fasteners configured to at least one of
rigidly attach the first part to the first edge member of the airfoil arrangement, or
hold one or more springs in place which press the second part in a direction of an extended position.

10. The guiding element according to claim 1, wherein the second part is at least partly arranged within a chamber formed by the first part and at least a portion of the track support element protrudes from the chamber when the second part is moved in a direction of an extended position.

11. The guiding element according to claim 1, wherein at least one of
the first edge member is a rib of the airfoil arrangement,
the second edge member is movably supported by the track device which is configured to be moved relative to the first edge member,
the first edge member and the second edge member are leading edge members, or
the biasing device is configured to press the track device by a force against a guiding element located on the opposite side of the track device.

12. The guiding element according to claim 1, being configured at least one of
as a track side guiding element for absorbing side loads acting on a slat track of the airfoil arrangement, or
to be mounted to an airfoil arrangement to extend and retract the second part in the spanwise direction.

13. A high lift airfoil arrangement for an aircraft, comprising
a first edge member,
a track device movably attached to the first edge member and supporting a second edge member, and
a guiding element according to claim 1.

14. The high lift airfoil arrangement according to claim 13, wherein the first edge member and the second edge member are leading edge members.

15. The high lift airfoil arrangement according to claim 13, wherein the high lift airfoil arrangement is a slat arrangement.

16. An aircraft wing comprising a high lift airfoil arrangement according to claim 13.

17. An aircraft comprising a high lift airfoil arrangement according to claim 13.

18. A method for producing a high lift airfoil arrangement for a wing of an aircraft, comprising the steps:
providing a first edge member of the high lift airfoil arrangement,
rigidly attaching to the first edge member one or more guiding elements to guide a movable track device configured to support a second edge member of the high lift airfoil arrangement;
attaching the track device to the first edge member,
wherein a surface of the track device is pressed against a movable track support element of the one or more guiding elements which is biased in a spanwise direction against the track device.

19. The method according to claim 18, wherein in the rigidly attaching step, at least two guiding elements are attached on opposite sides of an installation position of the track device before the step of attaching the track device to the first edge member is performed.

20. The method according to claim 18, wherein the at least one guiding element is a guiding element comprising:
a first part configured to be fixed to a first edge member of a high lift airfoil arrangement of an aircraft;
a second part comprising at least one track support element configured to movably support a track device of a second edge member of the high lift airfoil arrangement,
wherein the second part is movably mounted to the first part and configured to move from a first position to a second position; and
a biasing device configured to bias the at least one track support element in the spanwise direction towards the track device.
